(19) United States
(12) Patent Application Publication
(10) Pub. No.: US 2003/0108384 A1
(43) Pub. Date: Jun. 12, 2003

(54) Polygonal interface between driving and driven components

(75) Inventors: Hsin-Hong Huang, West Bloomfield, MI (US); Richard S. Kean, Shelby Township, MI (US)

Correspondence Address: David W. Okey, BRINKS HOFER GILSON & LIONE, P.O. Box 10395, Chicago, IL, 60610, US

(73) Assignee: Visteon Global Technologies, Inc.

(21) Appl. No.: 10/017,924

(22) Filed: Dec. 7, 2001

(51) Int. Cl. F16D 1/00; B25G 3/00; F16B 7/00

(52) U.S. Cl. 403/383

(57) ABSTRACT

A power transmitter, such as an automotive vehicle drive shaft, mounts via a pinion gear to a differential to transmit mechanical power to the wheels and thus propel the automotive vehicle. Such drive shafts traditionally mount to a differential/axle pinion gear interface flange via a splined connection, with a male spline on the axle pinion gear and a female spline on a flange or other mounting device. Replacing the spline with a polygonal coupling reduces backlash and rotational imbalance, and enables a better connection between the drive shaft and the differential. The polygonal fitting may also be used for making other connections.

### FIELD OF THE INVENTION

The present invention is directed to power transmission devices, and in particular to an interface between a driving member and a driven member, such as the joint between a drive shaft and a differential, or the joint between a differential and a wheel.

### BACKGROUND OF THE INVENTION

Power transmitters may be complicated machines, packing many mechanical devices into ever-smaller packages in order to meet cost, quality and weight targets. One area in which quality may be greatly improved is the interface between a drive shaft and differential driven by the drive shaft. This interface typically includes a splined connection, as depicted in FIG. 1. In such a configuration, a spline is machined onto an exterior surface of the end of an axle pinion gear. A matching female spline is then machined onto a companion flange for mounting a drive shaft to the axle. Whether the drive shaft-mounting device is a flange or another type of device, there are many disadvantages associated with the use of such a configuration.

The current manufacturing process for an axle pinion gear, such as the one shown in FIG. 1, cannot hold tight concentricity tolerances. Machining the axle pinion gear assembly 10 shown in FIG. 1 includes the steps of procuring a forging. The forging is then rough-machined, typically turning to reveal at least one datum for alignment. The forging is then hobbed on one end to form a gear 12. The external spline 14 is then roll-formed. The threads 20, which typically do not require a high degree of concentricity, may be roll-formed onto the shaft and the partially-machined part is then heat-treated. After heat-treating, the journals 16, 18 are ground to a specified tolerance, since it is desired to have the journals 16, 18 concentric with the shaft and with the gear 12.

In this axle pinion gear assembly, it may be difficult to hold the concentricity between the spline and shaft, primarily because it is heat treated after the splines are formed. Heat treating after machining induces distortion when not all parts and not all portions of the same part react the same way to the intense heat and stresses of the heat-treating process. Splined connections have additional shortcomings. Because splines are essentially gears, albeit defined on a shaft, they invariably are manufactured with some degree of clearance so that the axle may mount to the flange or other power-transmission component. While convenient for assembly, this clearance becomes backlash once the axle and flange are assembled and put into service. Backlash may contribute to fretting and wear between the male and female splines, leading to premature failure.

What is needed is an improved connection between the differential and the flange and a connection having less backlash. What is also needed is an improved method of manufacturing the interface between the differential and the drive shaft so that parts are better able to hold manufacturing tolerances, and in particular, to demonstrate improved concentricity between the flange, the shaft and the pinion gear.

### BRIEF SUMMARY OF THE INVENTION

The present invention meets these and other needs with an improved design of the interface or connection between a driving member and a driven member. In one embodiment, a driving member has a polygonal length, the polygonal length having at least one surface selected from the group consisting of concave, convex, and straight surfaces. The driven member has a matching polygonal surface, that is, the driven member has a surface that is convex if the driving member has a concave surface, or the driven member has a concave surface if the driving member has a convex surface. Alternatively, the driving and driven members may have surfaces that are neither concave nor convex, but are instead straight surfaces. At least one of the driving and driven surfaces has a twisted portion along an axis of its length. In some embodiments, the twisted portion has a twist angle of from about 0° 10′ to about 1°.

Another embodiment of the invention is a coupling for an automotive drive shaft. The coupling comprises a drive shaft having a length selected from the group consisting of concave, convex, and straight surfaces. The coupling also comprises a mounting device having a polygonal length that matches that of the drive shaft. One of the polygonal lengths has a twisted portion along its length, with an angle of from about 0° 10′ to about 1°. Another embodiment of the invention is a coupling for transmitting rotational energy from a driving member to a driven member. The coupling comprises a driving member having a polygonal length. The coupling also comprises a driven member with a matching polygonal length. A portion of one of the polygonal lengths has a twisted section along its length, having a twist angle of from about 0° 10′ to about 1°.

Another aspect of the invention is a method of interfacing a driving member with a driven member. The method comprises providing a driving member having a polygonal length and a driven member having a matching polygonal length. At least one of the polygonal lengths has a twisted section along an axis of the length, having a twist angle of from about 0° 10′ to about 1°. The method then includes joining the driving member with the driven member.

Another aspect of the invention is a method of manufacturing an axle pinion gear. The method includes furnishing a forging and rough machining the forging. The method also includes hobbing a gear at a first end of the axle pinion gear and then heat-treating the axle pinion gear. After heat treating, the method includes hardturning at least two journals and a polygonal length on the shaft. In this method, the shaft is not ground and the concentricity between the journals and the polygonal portion of the shaft is at least 0.001 inches (0.0254 mm).

Using polygonal interfaces has great advantages over using the present splined connection between a driving portion and a driven portion. For example, the twisted polygonal connection greatly reduces or virtually eliminates backlash, thus lowering the wear between the mating surfaces. In addition, the manufacturing yield is improved and scrap is reduced, because the polygonal surfaces are machined after heat treat. In contrast, the existing process requires splines to be cut into the shaft before heat treat, and the shaft is then subject to uncontrolled distortion during the heat treat process. In addition, the same hardturning step may also be applied to the journals on the shaft, thus insuring better concentricity between the shaft, the journals, and the polygonal interface. The invention has many aspects, and there are many ways of practicing the invention, as will be seen from the drawings and detailed description below.

### BRIEF DESCRIPTION OF SEVERAL VIEWS OF THE DRAWINGS

FIG. 1 is a perspective view of a prior art axle pinion gear having a splined interface.

FIG. 2 is a perspective view of an axle pinion gear having a male polygonal interface according to the present invention.

FIG. 3 is a perspective view of a companion flange having a female polygonal interface to match the interface of FIG. 2.

FIG. 4 is a perspective view of the embodiments of FIGS. 2 and 3 assembled.

FIG. 5 is an end, perspective view of the axle pinion gear shaft with a polygonal interface.

FIG. 6 is a representation of the measurement of convexity or concavity of the polygonal surfaces.

FIGS. 7 and 8 are polygonal surfaces according to the present invention.

FIG. 9 is a flow diagram illustrating a method of manufacturing an axle pinion gear having a twisted polygonal interface.

### DETAILED DESCRIPTION OF THE PRESENTLY PREFERRED EMBODIMENTS OF THE INVENTION

The invention makes use of machining technology licensed from IPROTEC Maschinen-und Edelstahiprodukte GmbH, Germany. The technology is revealed in one or more European patents, including EP 0907458B1, which is hereby incorporated by reference. This patent concerns a method for machining a non-circular part by using a lathe only, rather than grinding, milling, or other more labor-intensive steps. In parts where concentricity along a length is desired, it should be clear that a lathe is a highly preferred method of production. The IPROTEC technology uses a lathe to fabricate a polygonal surface rather than machines that would more typically be used, such as milling machines, machining centers, or grinders. While the IPROTEC technology may be the best way to practice the present invention, other ways to machine polygonal surfaces are known and may be used, including the other manufacturing methods mentioned above.

FIG. 1 is a perspective view of a prior art axle pinion gear 10 for use in an automotive application. The axle pinion gear includes a gear 12 for interfacing with an automotive differential. The axle pinion gear also includes a spline 14 for interfacing with a companion flange or other component of an automobile or truck. Journals 16 and 18 are provided for matching bearings to guide the axle pinion gear. Threaded end 20 is provided to secure the flange or other transmission component in an axial direction with a flange nut. In designing the axle pinion gear, it is important that the spline, the gear and journals be concentric for efficient transmission of power, and also for other reasons, such as quiet operation and long life. The principal disadvantage of the axle pinion gear depicted in FIG. 1 is the inherent backlash that must be tolerated in the splined connection, and the fact that the gear and the spline must be machined before heat-treating. Because the part is subject to distortion during heat-treating, some movement is expected between the gear and the spline. That movement frequently leads to scrapping production parts and is desirably eliminated. To define terms relating to driving and driven members, the driving member is defined as the part nearer the source of power, and the driven member is the portion farther from the source of power. Both the companion flange and the axle pinion gear are driven by a drive shaft (not shown), and are in series with the drive shaft. However, the companion flange receives power directly from the drive shaft and the axle pinion gear receives power from the companion flange. Therefore, we define the companion flange as the driving member, since its rotation drives the axle pinion gear, and the axle pinion gear is the driven member. These definitions should not be confused with typical automotive terminology, in which the axle pinion gear may be termed the driving member because it drives the entire differential.

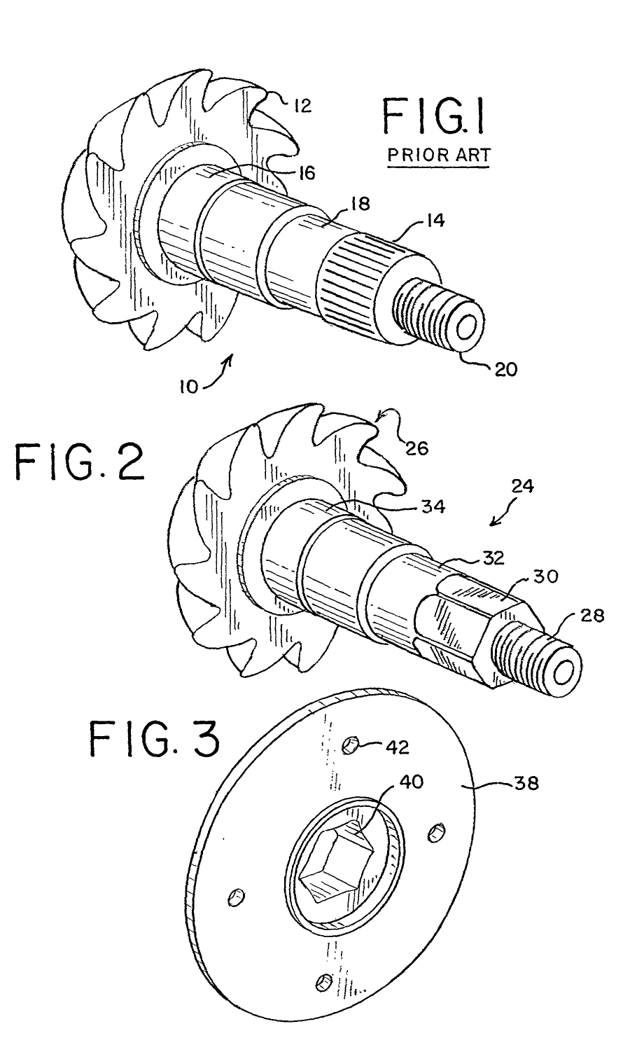

FIG. 2 is a perspective view of an axle pinion gear assembly 24 according to the present invention. Axle pinion gear assembly 24 is meant for use in automotive applications, such as in trucks and automobiles, although other applications may also take advantage of the present invention. The axle pinion gear assembly 24 includes a gear 26 at one end for interfacing with a differential. The axle pinion gear assembly also includes a threaded surface 28 at the opposite end for a nut that will secure a companion flange in an axial direction. The axle pinion gear includes a polygonal surface 30, described below, in this case a hexagonal surface with a slight concavity on each of the six surfaces. The polygonal interface secures the companion flange in a radial direction. The axle pinion gear also includes journals 32 and 34 for bearing surfaces. FIG. 3 depicts matching companion flange 38 for the axle pinion gear assembly 24. Companion flange 38 preferably has an outer surface with a plurality of holes 42 for attachment to a drive shaft yoke, and also has a polygonal surface 40 to match the polygonal surface 30 of the axle pinion gear. The polygonal surface 40 of the companion flange has a slight convexity to match the concave surfaces of the axle pinion gear.

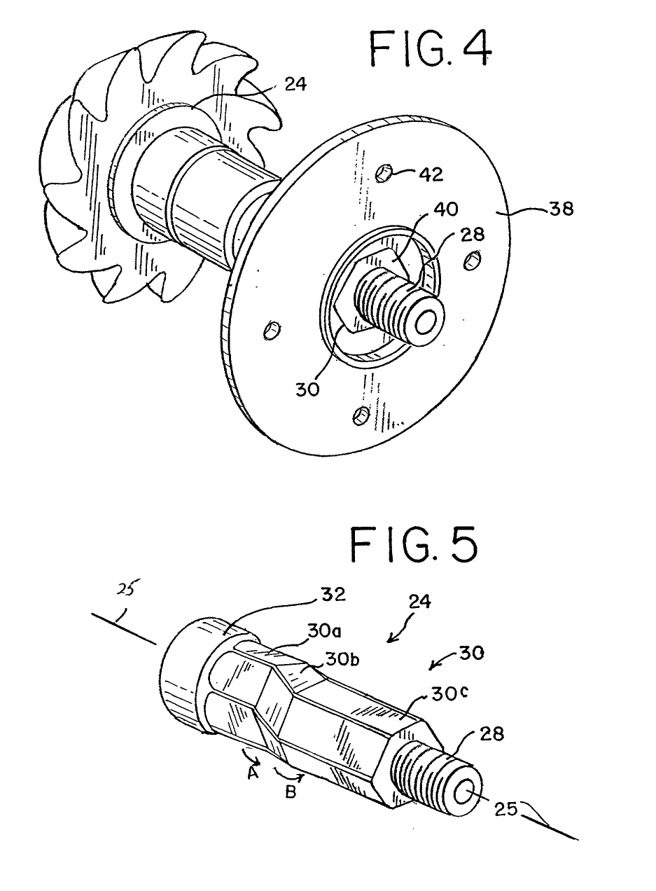

The assembled parts are depicted in FIG. 4. Axle pinion gear 24 and its polygonal surface 30 fit into companion flange 38 and its matching polygonal surface 40. The holes of the flange are available for mounting to a drive shaft yoke (not shown) and the threads 28 of the axle pinion gear are adapted to receive a retaining nut (not shown). FIG. 5 is an end, perspective view of a portion of the axle pinion gear of FIG. 2. As mentioned above, the axle pinion gear comprises a threaded end 28, a polygonal surface 30, and at least one bearing surface 32. Polygonal surface 30 may actually be separated into three portions along its length and along the axis 25 of the shaft. The portions are of preferably of roughly equal length, although this is not required, as will be seen.

First portion 30a is machined in alignment with the axis 25 of the axle pinion gear 24. Portion 30b is machined so as to provide a small twist, either clockwise or counterclockwise, relative to the axis of the shaft. Finally, portion 30c is machined with a second twist equal and opposite to that given to section 30b. The effect of the middle portion, 30b, is as though it were twisted along its outer surface. The angle is small, preferably from about 0° 10′ to about 1°. In another embodiment, the angle is selected from a narrower range, from about 0° 20′ to about 0° 50′, and in yet another embodiment, the angle is close to about 0° 35′. It has been found that in shafts from about 1″ diameter to about 3″ in diameter, this twist in the middle section is effective in eliminating backlash. At the same time, the angle is not so great that it is difficult to assemble the parts using known methods for assembling parts with interferences. These methods include thermal techniques and techniques using a mechanical advantage.

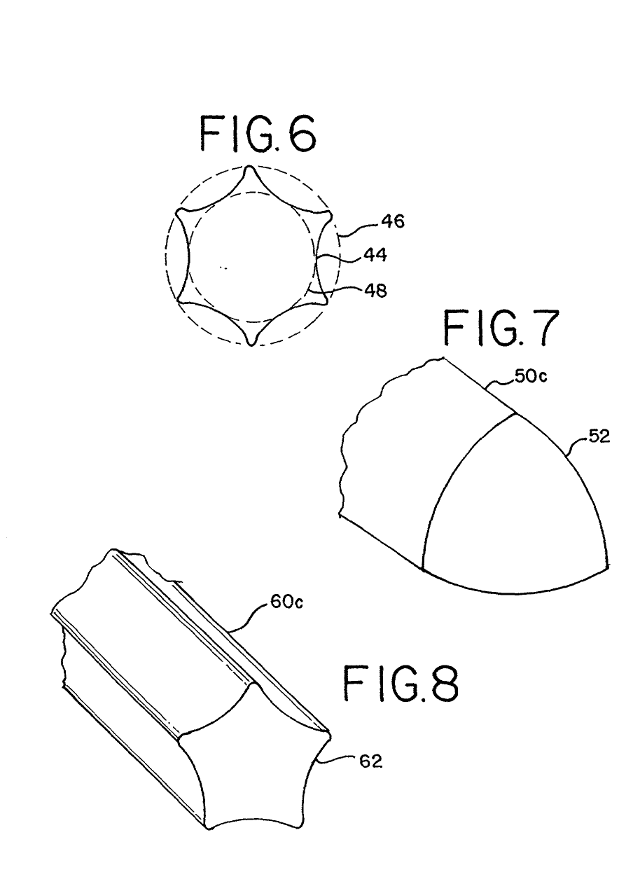

The twist is only machined onto one of the two parts, preferably the male portion, while the matching part, for instance the female portion, is kept straight. It may be easier to machine the twist onto the male portion of the polygonal interface, that is, onto the shaft, although the twist may instead be machined onto the female portion. When assembled, the outer part, 30c fits readily into the female portion. When further assembled, portion 30b induces torsion into the shaft and into the mating portion of the female polygonal interface. When the assembly is completed, first portion 30a will be in torsion against the mating portion of the female in one direction, and outer portion 30c will be in torsion in the opposite direction, resisting the torsion of the middle portion. When the angle is kept small, these small interferences will eliminate backlash and thus reduce the wear of the male and female polygonal surfaces. An important part of the design of the polygonal interfaces is the interface itself and the degree of convexity or matching concavity. A polygonal surface according to the present invention may have from 3 to any number of sides. However, as the number of sides increases, manufacturing and programming complexity will also increase for programming the lathes that may be used to turn the shaft and manufacture the part. It has been found that polygonal parts with a relative eccentricity of up to about 4% may preferably be used. Eccentricity is defined as shown in FIG. 6. A polygonal (in this case, hexagonal) surface 44 is circumscribed by circle 46 at its outermost points. An inner circle 48 is scribed at the innermost points. The eccentricity (e) of the polygon is defined as the difference between the diameter of the outer circle 46 (Dₒᵤₜ) and the inner circle 48 (Dᵢₙ). [e=½(Dₒᵤₜ−Dᵢₙ)]. The relative eccentricity (E) is defined in percentage terms as the eccentricity divided by the average diameter of the outer circle 46 (Dₒᵤₜ) and the inner circle 48 (Dᵢₙ). [E=(e/D_{middle})×100%], and [D_{middle}=½(Dₒᵤₜ+Dᵢₙ)]. It is clear that as the inner circle approaches the outer circle, there is less eccentricity, until the sides of the “polygon” converge to a single circle (e=0). While this certainly possible, it is preferable to have at least about 1.5% relative eccentricity in the concavity or convexity of the polygon used for mating surfaces. The reason is that with a smaller eccentricity the tangential stresses tend to point closer to the center of the shaft, which in turn creates a higher shear stress. And with a greater eccentricity, especially concavity in a male driven member, the tangential stress points away from the center of the shaft, hence creating a lower shear stress. Therefore, while a concave surface on a male driven member is only one embodiment, it is a preferred embodiment.

In addition to the hexagonal surfaces featured thus far, other shapes of polygonal surfaces may be used. For instance, convex trilobal surfaces 50c may be used on shaft 52, as shown in FIG. 7. Concave pentagonal surfaces 60c on shaft 62, may be used, as shown in FIG. 8. It should be understood that the shaft of which surfaces 50c or 60c are a part, also consists of inner portions 50a and 50b, or 60a and 60b (not shown), wherein section 50b or 60b is twisted from about 0° 10′ to about 1°, more preferably from about 0° 20′ to about 0° 50′, and even more preferably about 0° 35′. The middle section, 50b or 60b, defines the twist in one direction from section 50a or 60a, and in the opposite direction to the section shown in FIGS. 7 or 8. In such embodiments, the three polygonal sections have the same number of sides.

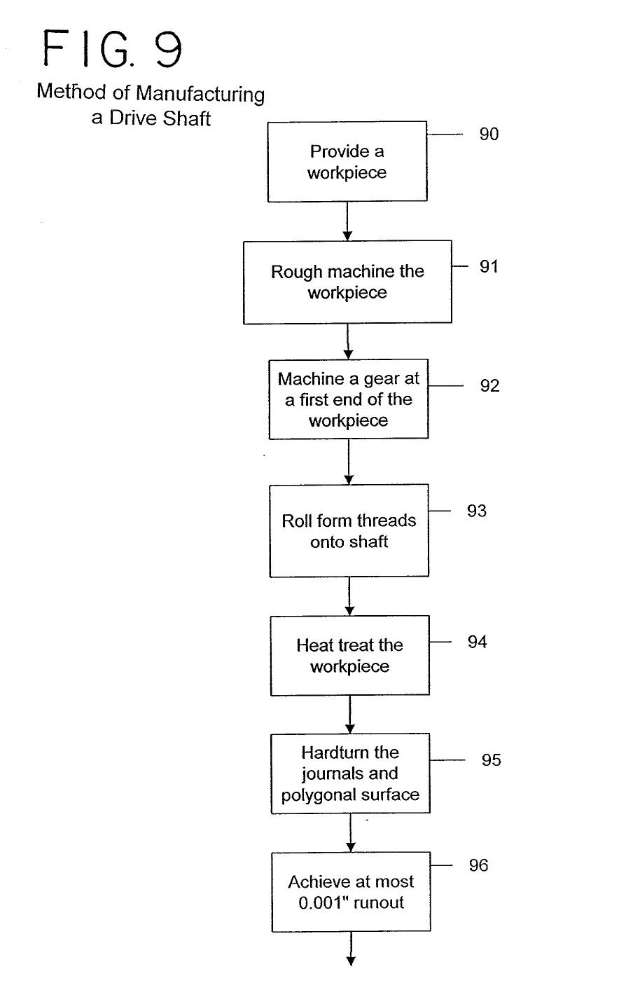

One aspect of the invention is a method of machining the axle pinion gear or other power transmitter incorporating the polygonal surface discussed above. The method of FIG. 9 includes providing 90 a workpiece for machining. As is well known to those in automotive arts, an axle pinion gear is preferably made from a forging. The method then includes rough machining 91. In the step of rough machining, primarily turning, several diameters and at least one datum should be formed onto the workpiece. The workpiece is then preferably hobbed, forming a gear 92 at a first end of the workpiece. A threaded surface may also be formed 93 on the end of the shaft for a flange-retaining nut. The rough shaft is then heat-treated 94, so that distortion and other effects will be manifest before the finish machining steps are taken. Most of the machining after heat-treating consists of hard turning, that is, turning on a lathe after the surface of the part has been made hard in the heat-treating process. After heat-treating, the journals are turned and the polygonal surface is formed 95 on the same lathe, in accordance with the IPROTEC technology mentioned above.

This method should yield excellent concentricity 96 between the shaft, the journals, the polygonal surface, and the gear. In one embodiment, concentricity should be no greater than 0.001″ of runout (approx. 0.0254 mm). An axle pinion gear assembly for an automotive application, such as a truck or a car, may be from about 8 inches to about 11 inches long, and may have a diameter of from about 1.0 inches to about 2.5 inches. Note that the IPROTEC technology is preferably used to form the polygon surfaces in the rough stage before heat-treating, in order to quickly remove greater amounts of material while preserving sufficient stock to accommodate movement of the material during heat-treating. The rough-turning or rough-machining step may also be used to form the journal diameters as close as possible to their finished dimensions, while retaining sufficient stock to hold tight concentricity tolerances for the finished axle pinion gear. Note also that concentricity is inverse to runout, and that a part has a higher concentricity when the runout used to measure concentricity is lower.

While automotive applications have been featured in the description above, the use of twisted polygonal interfaces is not limited to axle pinion gear, nor is their use limited to automotive applications. For instance, twisted polygonal surfaces may be used in any power-transmission application in which backlash or machining quality may be an issue. Thus, mating twisted polygonal surfaces may be used to transmit power from a flywheel to a differential, in the same manner that power is transmitted from a drive shaft to a differential in the examples shown above. Other applications may include a power take off (PTO) fitting from a tractor to an implement, such as from a PTO shaft of a truck or tractor to an auger, a winch, or other device requiring shaft power. Twisted polygonal surfaces and fittings may also be used in power transmission applications other than automotive. For instance, they may be used as mechanical linkages in compressors, pumps, machine tools, mechanical drives, motors, generators, and many other applications.

It is therefore intended that the foregoing description illustrates rather than limits this invention, and that it is the following claims, including all equivalents, which define this invention. Of course, it should be understood that a wide range of changes and modifications may be made to the embodiments and preferences described above. Accordingly, it is the intention of the applicants to protect all variations and modifications within the valid scope of the present invention. It is intended that the invention be defined by the following claims, including all of the equivalents thereto.

What is claimed is:

1. An interface between a driving member and a driven member, the interface comprising:
a driving member having a polygonal length, said polygonal length having at least one surface selected from the group consisting of concave, convex and straight surfaces; and
a driven member having a matching polygonal length,
wherein a portion of one of the polygonal lengths is twisted along an axis of the length.

2. The interface of claim 1 wherein the twist is from about 0° 10′ to about 1°.

3. The interface of claim 1 wherein the driven member comprises a shaft having a male polygonal length.

4. The interface of claim 1, further comprising a second twist along the axis of the length, said second twist in a direction opposite the twisted portion.

5. The interface of claim 1 wherein the driven member comprises a shaft having a male polygonal length with at least one portion of the length twisted from about 0° 20′ to about 0° 50′.

6. The interface of claim 1 wherein one of the driving member and the driven member is straight.

7. The interface of claim 1 wherein the polygonal length has a relative eccentricity of from about 1.5% to about 4%.

8. The interface of claim 1 wherein the driven member comprises a shaft having a concave male polygonal length with a number of sides selected from the group consisting of 3 to 12.

9. A method of interfacing a driving member with a driven member, the method comprising:
providing a driving member having a polygonal length and a driven member with a matching polygonal length, wherein one of the driving member and the driven member has at least one portion of the length twisted from about 0° 10′ to about 1° along an axis of the length; and
joining the driving member with the driven member.

10. The method of claim 9 wherein the driven member comprises a shaft and the driven member comprises a flange.

11. The method of claim 9 wherein the driven member comprises a shaft having a male polygonal length.

12. The method of claim 9 wherein the driven member comprises a shaft having a male polygonal length with at least one portion of the length twisted from about 0° 20′ to about 0° 50′.

13. The method of claim 9 wherein the driving member and the driven member comprise one of a group consisting of a compressor, a pump, a machine tool, a mechanical drive, a generator, and a motor.

14. A coupling for an automotive drive shaft, the coupling comprising:
a shaft having a polygonal length, said polygonal length selected from the group consisting of concave, convex and straight surfaces; and
a mounting device having a matching polygonal length, wherein one of the mounting device and the shaft has at least one portion of the polygonal length twisted from about 0° 10′to about 1°.

15. The coupling of claim 14 wherein the mounting device comprises a flange.

16. The coupling of claim 14 wherein the driven member comprises a male polygonal length with at least a portion of the length twisted from about 0° 20′ to about 0° 50′.

17. The coupling of claim 14 wherein the polygonal length has a relative eccentricity of from about 1.5% to about 4%.

18. The coupling of claim 14, wherein one of the shaft and the mounting device are straight.

19. The coupling of claim 14 wherein the driven member is a shaft having a concave male polygonal length with a number of sides selected from the group consisting of 3 to 12.

20. A coupling for transmitting rotational energy from a driving member to a driven member, the coupling comprising:
a driving member having a polygonal length; and
a driven member having a matching polygonal length, wherein at least a portion of one of the members has a twist of from about 0° 10′ to about 1°.

21. The coupling of claim 20 wherein the driving member is selected from the group consisting of an axle, a half axle and shaft.

22. The coupling of claim 20 wherein the driven member has a male polygonal length including a twist from about 0° 20′ to about 0° 50′.

23. The coupling of claim 20 wherein the polygonal length has a relative eccentricity of from about 1.5% to about 4%.

24. The coupling of claim 20 wherein the driven member is a shaft having a concave male polygonal length with a number of sides selected from the group consisting of 3 to 12.

25. The coupling of claim 20 wherein one of the members is straight.

26. A method of manufacturing an axle pinion gear, the method comprising:
furnishing a forging;
rough machining the forging;
hobbing a gear at a first end of the shaft;
heat-treating the shaft; and
hardturning at least two journals and a polygonal length on the shaft, wherein the shaft is not ground and the concentricity between the journals and the polygonal length is at least 0.001 inches (0.0254 mm).

27. The method of claim 26 wherein the polygonal length manufacturing by hard turning has a portion twisted from about 0° 10′ to about 1°.

28. The method of claim 26 further comprising rollforming threads on a second end of the shaft before the step of heat-treating.

29. The method of claim 26 wherein components of the polygonal interface are hardturned to a relative eccentricity of from about 1.5% to about 4%.
